(19) United States
(12) Patent Application Publication
(10) Pub. No.: US 2017/0260073 A1
(43) Pub. Date: Sep. 14, 2017

(54) SLUDGE TREATMENT SYSTEM WITH SLUDGE DRYING ACCELERATION FUNCTION

(71) Applicants: Ju-Yun Gu, Taipei City (TW); Wei-Ting Hsu, New Taipei City (TW); Yu-Feng Wang, Taipei City (TW); Wei-Shuin Chen, New Taipei City (TW)

(72) Inventors: Ju-Yun Gu, Taipei City (TW); Wei-Ting Hsu, New Taipei City (TW); Yu-Feng Wang, Taipei City (TW); Wei-Shuin Chen, New Taipei City (TW)

(21) Appl. No.: 15/066,784

(22) Filed: Mar. 10, 2016

(51) Int. Cl. C02F 3/32; A01G 31/02; C02F 3/30; B01D 21/00; B01D 21/24

(52) U.S. Cl. CPC C02F 3/327; B01D 21/0003; B01D 21/2444; B01D 21/0087; C02F 3/30; A01G 31/02; C02F 2001/007

(57) ABSTRACT

A sludge treatment system with sludge drying acceleration function includes at least one sedimentation tank, at least one sludge pipe, and at least one group of hydroponic plant. The at least one sedimentation tank is disposed at the downstream of a reservoir. The at least one sludge pipe is disposed in the at least one sedimentation tank for leading the sludge into the at least one sedimentation tank through a leading method, such that the sludge in the at least one sedimentation tank is divided into a water layer and a mud layer. The at least one group of hydroponic plant is planted in the water layer of the at least one sedimentation tank, such that the growth of the at least one group of hydroponic plant accelerates the sludge drying process in the sedimentation tank.

### BACKGROUND OF THE INVENTION

1. Field of the Invention

The present invention relates to sludge treatment systems, and more particularly, to a sludge treatment system with sludge drying acceleration capability.

2. Description of the Related Art

Under the effect of topography and climate, reservoirs become an important tool for efficient water resource utilization in human life. Recently, due to the negative effect of geographic environment of mountain region and man-made exploitation of natural resource, reservoirs are seriously silted up. Thus, professionals in relevant field develop a method for reservoir sludge treatment, such as reservoir dredging by use of a dredger, wherein the dredger stretches a sludge suction pipe deep into the reservoir, sucks the sludge with a pump, and uses a transport pipe to transport the sludge to a sedimentation tanks located on the highest topographic level. When the highest sedimentation tank is filled up, the sludge tends to flow into other lower sedimentation tanks. Subsequent, moisture content of the sludge is separated due to the compression effect caused by the specific gravity difference between the water and mud, and the moisture content is removed through vaporization by sunlight or water infiltration into stratum, whereby the sludge is dehydrated and dried.

However, such a traditional civil engineering treating method which requires at least five years duration of treatment is not efficient.

### SUMMARY OF THE INVENTION

For improving aforementioned issues, a sludge treatment system with sludge drying acceleration capability is disclosed, wherein the sedimentation tank is applied for facilitating the growth of a hydroponic plant group, so as to provide higher economic benefit and biological vitality.

For achieving the objectives above, a sludge treatment system with sludge drying acceleration capability is provided, comprising:

at least one sedimentation tank, disposed at the downstream of a reservoir;

at least one sludge pipe, disposed in the at least one sedimentation tank for leading the sludge into the at least one sedimentation tank through a leading method, such that the sludge in the at least one sedimentation tank is divided into a water layer and a mud layer after a sedimentation period; and

at least one hydroponic plant group, planted in the water layer of the at least one sedimentation tank, such that the sludge drying process is accelerated by use of the growing of the at least one hydroponic plant group.

With such configuration, the hydroponic plant group is planted in the water layer of the sedimentation tank. During the complete growing period of the hydroponic plant group, the mud layer of the sludge in the sedimentation tank is gradually dried; also, the drying process of the sludge is accelerated. Furthermore, the hydroponic plant group is able to be harvested for selling, so as to increase the general economic value. In addition, the dried mud is allowed to be reused in various ways.

### BRIEF DESCRIPTION OF THE DRAWINGS

FIG. 1 is a schematic view of the sludge treatment system illustrating the implementation status of the present invention.

FIG. 2 is a schematic view illustrating the sedimentation in accordance with the present invention.

FIG. 3 is a schematic view illustrating the wetland ecological field in accordance with the present invention.

### DETAILED DESCRIPTION OF THE INVENTION

The aforementioned and further advantages and features of the present invention will be understood by reference to the description of the preferred embodiment in conjunction with the accompanying drawings where the components are illustrated based on a proportion for explanation but not subject to the actual component proportion.

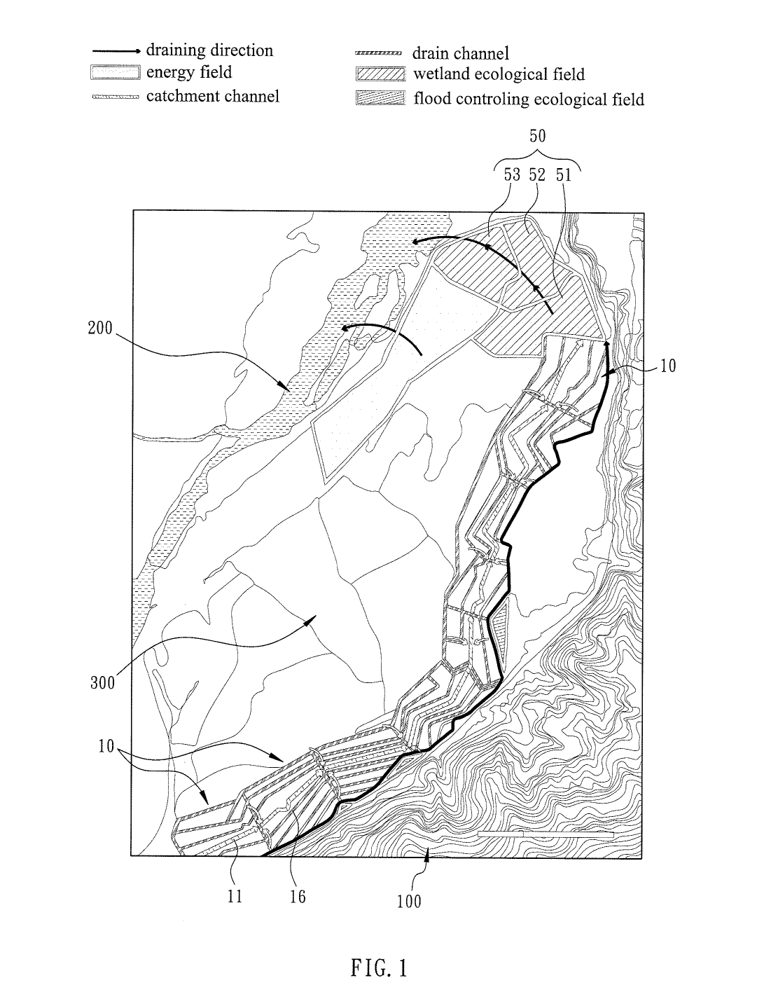

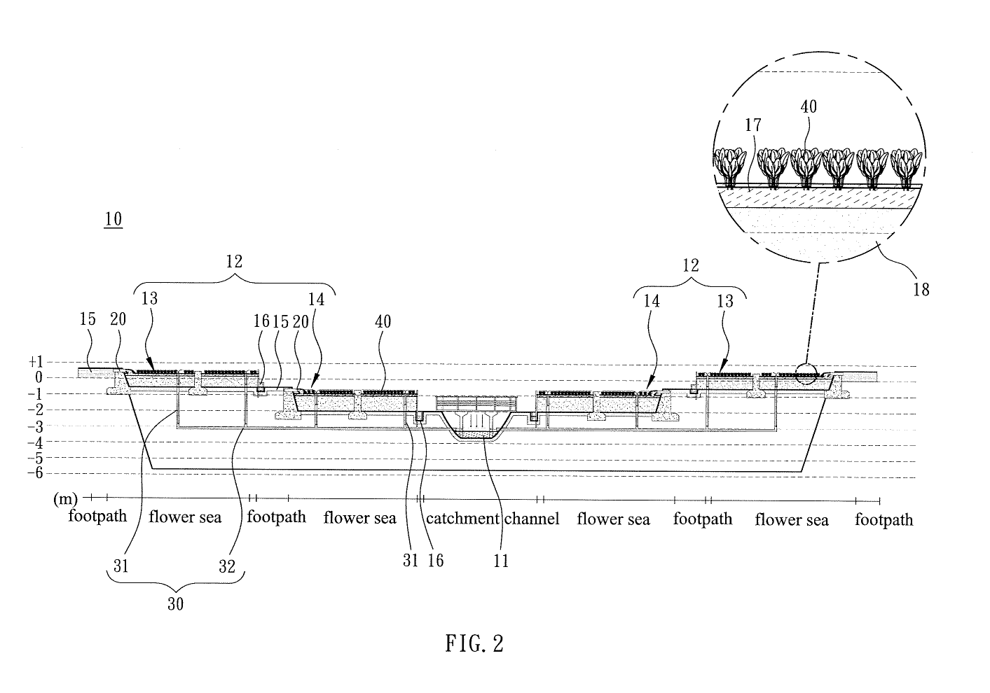

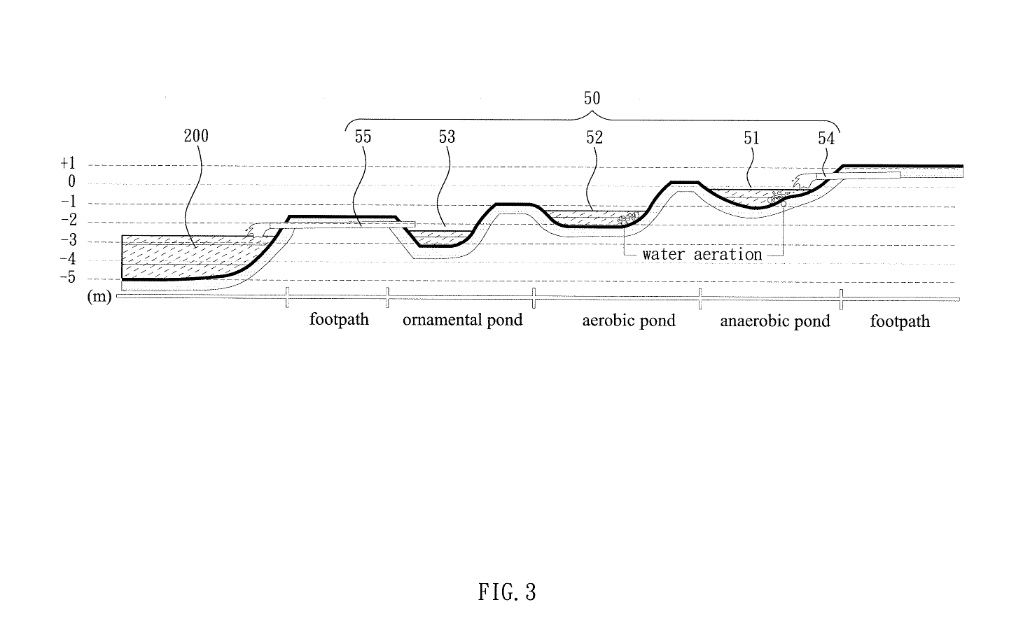

Referring to FIG. 1 to FIG. 3, the present invention provides a sludge treatment system with sludge drying acceleration capability, comprising plural sedimentation tanks 10, plural sludge pipes 20, plural drain devices 30, and plural hydroponic plant groups 40.

The sedimentation tanks 10 are disposed at the downstream of a reservoir and neighborly arranged according to the topographic levels from the highest one to the lowest one. Preferably, the sedimentation tanks 10 are disposed between a hill 100 and a stream 200, and a community 300 is located between the sedimentation tanks 10 and the stream 200, as shown in FIG. 1. Also, in FIG. 1, the sedimentation tank 10 with the highest topographic level is arranged at the southern position in the drawing, and sedimentation tank 10 with the lowest topographic level is arranged at the northern position in the drawing.

Each sedimentation tank 10 has a catchment channel 11 and two sludge sedimentation areas 12 disposed on two sides of the catchment channel 11. The topographic level of the catchment channel 11 is lower than the topographic level of the two corresponding sludge sedimentation areas 12, and the two catchment channels 11 of the two neighboring sedimentation tanks 10 are connected with each other. The catchment channel 11 of the lowest sedimentation tank 10 is led into the stream 200. Each sludge sedimentation area 12 of each sedimentation tank 10 is divided into a first sedimentation area 13 having a higher topographic level and a second sedimentation area 14 having a lower topographic level against the first sedimentation area 13, such that each of the sludge sedimentation areas 12 is arranged to form a terrace. Each second sedimentation area 14 is disposed between the corresponding first sedimentation area 13 and the corresponding catchment channel 11. The depth of the first sedimentation area 13 and the second sedimentation area 14 is between 0.85 meters to 1.5 meters, and the depth of the catchment channel 11 is 2 meters.

Further, a footpath 15 is disposed on the outer side of the first sedimentation area 13 and between the first sedimentation area 13 and the second sedimentation area 14, respectively, so as to provide a path for people and vehicles to pass. Also, a drain channel 16 is disposed between the first sedimentation area 13 and the second sedimentation area 14 and between the second sedimentation area 14 and the catchment channel 11, respectively, so as to lead the overland flow into the stream 200.

The plural sludge pipes 20 are embedded under the ground to be provided to the two first sedimentation areas 13 and the two second sedimentation areas 14 of each sedimentation tank 10, respectively, so as to lead the sludge of the reservoir thereinto by use of a leading method. Preferably, the sludge is led by use of the known leading method of reservoir dredging. The sludge at the bottom of the reservoir is sucked out by the dredger and led into each sedimentation tank 10 by use of the sludge pipes 20 disclosed by the present invention. After settling in a sedimentation period for about 3 to 7 days in the first sedimentation areas and the second sedimentation areas 14 of the sedimentation tank 10, the sludge is divided into a water layer 17 and a mud layer 18.

The plural drain devices 30 are provided to each sludge sedimentation areas 12 and at the same time provided with plural shafts and a connection pipe 32, respectively. The shaft 31 passes through the first sedimentation area 13 and the second sedimentation area 14. The connection pipe 32 connects the bottom part of the shaft 31 with the catchment channel 11. Therefore, the drain device 30 drains the excess water of the water layer 17 into the catchment channel 11.

The plural hydroponic plant groups 40 are planted in the water layer 17. The hydroponic plant groups 40 are able to be species of annual flowers, so as to form the sedimentation tank 10 into a flower sea. Also, plants carer is able to grow different seasonal flower species alternately in the first sedimentation areas 13 and the second sedimentation areas 14, so as to realize a season-based varying landscape. Also, the hydroponic plant groups 40 are able to be vegetables. Especially, the hydroponic vegetables are able to be grown in the water layer 17 of the first sedimentation areas 13 near the community 300, whereby a vegetable farm combined with an outdoor square is formed for the residents of the community 300.

The wetland ecological field 50 is adjacent to the sedimentation tank 10 having the lowest topographic level, and is provided with an anaerobic pond 51, aerobic pond 52, and ornamental pond 53 that are arranged orderly from the one with the highest topographic level to the one with the lowest topographic level. The depth of the anaerobic pond 51, aerobic pond 52, and ornamental pond 53 is about 1 meter for growing different hydrophyte groups, respectively. The wetland ecological field 50 has a wetland inlet culvert 54 and a wetland outlet culvert 55. The wetland inlet culvert 54 is connected between the anaerobic pond 51 and the catchment channel 11 of the lowest sedimentation tank 10. The wetland outlet culvert 55 is connected between the ornamental pond 53 and the stream 200. Therefore, when the water gathered through the catchment channel 11 of the sedimentation tank 10 flows into the anaerobic pond 51, the water is then led from the anaerobic pond 51 with the higher topographic level to the ornamental pond 53 with the lowest topographic level. As a result, the water flows through the hydrophyte groups to be purified and enters the stream 200 through the wetland outlet culvert 55.

With such configuration, the present invention redesigns the traditional sedimentation tank. The sedimentation tank 10, through the land levelling method, is provided with a catchment channel 11 and two terrace-shaped sludge sedimentation areas 12, wherein plural hydroponic plant groups 40 are planted in the water layers 17 of each sludge sedimentation areas 12. During the hydroponic plant groups 40 being full grown, the mud layer 18 of each sludge sedimentation area 12 gradually dries, such that the whole sludge drying process is accelerated.

In addition, the hydroponic plant groups 40 are allowed to be harvested for selling, thus increasing the general economic value. The dried mud layer 18 is able to be recycled for different usages, such as geotechnical engineering material or architectural component. Also, the dried mud thereof is able to be used for making flowerpots and combined with the harvested hydroponic plant groups 40 as commercial commodities.

Furthermore, with the combination of the hydroponic plant groups 40 grown in the sedimentation tanks 10 and the hydrophytes grown in the wetland ecological field 50, the sludge treatment system is turned into a people-friendly landscape provided with ecological variety, such that a balance between the community 300 and the sedimentation tanks 10 is reached, facilitating the development of the community 300.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A sludge treatment system with sludge drying acceleration function, comprising:
at least one sedimentation tank, disposed at the downstream of a reservoir;
at least one sludge pipe, disposed in the at least one sedimentation tank for leading the sludge into the at least one sedimentation tank through a leading method, such that the sludge in the at least one sedimentation tank is divided into a water layer and a mud layer after a sedimentation period; and
at least one hydroponic plant group, planted in the water layer of the at least one sedimentation tank, such that the sludge drying process is accelerated by use of the growing of the at least one hydroponic plant group.

2. The sludge treatment system of claim 1, further comprising plural drain devices, wherein the at least one sedimentation tank, the at least one sludge pipe, and the at least one hydroponic plant group are provided in a plural amount of at least two; the plural sedimentation tanks are neighborly arranged orderly from the sedimentation tank having the highest topographic level to the sedimentation tank having the lowest topographic level, each sedimentation tank having a catchment channel and two sludge sedimentation areas disposed on two sides of the catchment channel, each catchment channel being topographically lower than the two sludge sedimentation areas, the catchment channels of each two neighboring sedimentation tanks being connected with each other, the catchment channel of the topographical lowest sedimentation tank being led into a stream; each sludge pipe is provided to the corresponding sludge sedimentation area, so as to lead the sludge in the reservoir into each sludge sedimentation areas by use of the leading method; each drain device is provided to the corresponding sludge sedimentation area for draining excess water of each water layer into the corresponding catchment channel; each hydroponic plant group is planted in the corresponding water layer.

3. The sludge treatment system of claim 2, wherein the sludge sedimentation areas of each sedimentation tank are arranged into a terrace shape, such that each sludge sedimentation area is divided into a first sedimentation area having a higher topographic level and a second sedimentation area having a lower topographic level, and each second sedimentation area is disposed between the corresponding first sedimentation area and the corresponding catchment channel.

4. The sludge treatment system of claim 3, wherein the drain device has plural shafts and a connection pipe, each shaft passing through the corresponding first sedimentation area and the corresponding second sedimentation area, respectively, each connection pipe connecting a bottom part of the shaft with the corresponding catchment channel.

5. The sludge treatment system of claim 3, wherein height of the first sedimentation area and the second sedimentation area is between 0.85 meters to 2.5 meters, and height of the catchment channel is 2 meters.

6. The sludge treatment system of claim 3, wherein a drain channel is disposed between the first sedimentation area and the second sedimentation area and at the same time disposed between the second sedimentation area and the catchment channel, respectively, so as to lead the overland flow into the stream.

7. The sludge treatment system of claim 3, wherein the hydroponic plant group are chosen between species of flower and vegetable.

8. The sludge treatment system of claim 2, further comprising a wetland ecological field and a hydrophyte group planted on the wetland ecological field, the wetland ecological field having a wetland inlet culvert and a wetland outlet culvert, the wetland inlet culvert connected with the catchment channel of the topographically lowest sedimentation tank, and the wetland outlet culvert connected with the stream.

9. The sludge treatment system of claim 8, wherein the wetland ecological field is provided with an anaerobic pond, an aerobic pond, and an ornamental pond arranged orderly, with the anaerobic pond having the highest topographic level and the ornamental pond having the lowest topographic level; the wetland inlet culvert is connected between the anaerobic pond and the catchment channel of the topographically lowest sedimentation tank, and the wetland outlet culvert is connected between the ornamental pond and the stream.
